(19) United States
(12) Patent Application Publication
(10) Pub. No.: US 2006/0266918 A1
(43) Pub. Date: Nov. 30, 2006

(54) Optical pick-up device

(75) Inventors: Soo-han Park, Yongin-si (KR); Seok-jung Kim, Suwon-si (KR); Jang-hoon Yoo, Seoul (KR); Hag-hyeon Jang, Seongnam-si (KR); Yong-han Yoon, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/337,593

(22) Filed: Jan. 24, 2006

(30) Foreign Application Priority Data
Jan. 24, 2005 (KR) 2005-6417

(51) Int. Cl. G02B 27/40; G02B 7/04

(52) U.S. Cl. 250/201.5

(57) ABSTRACT

An optical pick-up device is provided that reduces aberrations in light irradiated from an optical recording meidu. The device includes a light source that outputs light for recordation and reproduction of information onto the optical recording medium. An objective lens irradiates the light onto the optical recording medium by concentrating the light. An actuator adjusts the movement of the objective lens to focus the light on at least one or more layers of the optical recording medium. A controller moves the objective lens to substantially reduce the aberration occurring in the light irradiated from the optical recording medium by driving the actuator, such that aberrations, such as asymmetrical aberrations or coma aberrations, may be reduced and corrected.

### CROSS REFERENCE TO RELATED APPLICATION

This application claims the benefit under 35 U.S.C. § 119(a) of Korean Patent Application No. 2005-6417, filed on Jan. 24, 2005, the entire disclosure of which is hereby incorporated by reference.

### BACKGROUND OF THE INVENTION

1. Field of the Invention

The present invention relates to an optical pick-up device. More particularly, the present invention relates to an optical pick-up device equipped with an actuator drivable in three directions.

2. Description of the Related Art

Optical recording media commonly used include Compact Discs (CD) and Digital Versatile Discs (DVD). Various technologies exist relating to an optical pick-up apparatus compatible with a high density optical disk in addition to the conventional and widely used optical disk, such as DVDs and CDs. Recently, Blue-ray Discs (BD) using blue ray have been marketed. The emergence of new optical recording media is intended for high density recordation, which is possible by shortening a wavelength of a light source or increasing the Numerical Aperture (NA) of an objective lens.

Although a wavelength of 650 nm and an NA of 0.6 are used for DVDs, use of a blue color light source having a wavelength of 408 nm and an increased NA of an objective lens of up to 0.85 should be used for a higher density optical disk.

However, concomitant with promotion of short wavelengths of the laser light source or a higher NA of an objective lens, a problem is expected for an optical pick-up device having a combination of a low NA objective lens and a comparatively long wavelength of a laser light source for implementing recordation and reproduction of information relative to the conventional optical disc, such as CDs and DVDs.

A problem arises in that spherical aberration occurs in an objective lens due to fine oscillating wavelength changes in the laser light source. When using a combination of a laser light source of short wavelength with an objective lens of high NA, the amount of defocusing of a focus is increased. An objective lens adopted at an optical pick-up device for implementing recordation or reproduction of information relative to BD has a high NA such that it is sensitive to the occurrence of coma aberrations.

There is another problem in that even in an optical pick-up device employing a finite optical system, the optical pick-up device is sensitive to astigmatism or coma that occurs due to changes in the incident angle of light in response to movement of the objective lens.

Referring to FIG. 1, when an incident angle of light grows larger, various aberrations occur. Among the variety of aberrations, it can be particularly noted that the amount of coma that is generated is enormous.

In view of the afore-mentioned problems, there is a need to correct the aberrations, such as coma and astigmatism, occurring in an optical pick-up device having a combination of a laser light source of short wavelength and an objective lens of high NA.

Accordingly, a need exists for an improved optical pick-up device having a laser light source of short wavelength and an objective lens of high NA that substantially reduces undesirable aberrations in the optical pick-up device.

### SUMMARY OF THE INVENTION

An object of the invention is to provide an optical pick-up device that substantially reduces aberrations, such as coma or astigmatism, that occurs in the optical pick-up device having a laser light source of short wavelength and an objective lens of high NA.

An optical pick-up device according to an exemplary embodiment of the present invention includes a light source outputting light for recordation and reproduction of information onto and from an optical recording medium. An objective lens irradiates the light onto the optical recording medium by concentrating the light. An actuator adjusts movement of the objective lens to focus the light to at least one or more layers of the optical recording medium. A controller seeks a position of the objective lens to reduce the aberration occurring in the light irradiated from the optical recording medium by driving the actuator.

The controller seeks a position of the objective lens from a current value or a voltage value inputted into the actuator.

The controller seeks a position of the objective lens using a light detection element disposed at the actuator.

Preferably, the light detection element is an optical sensor for sensing a position of the objective lens.

Preferably, the controller automatically adjusts an inclination of the actuator using asymmetrical structure of the actuator.

The actuator is disposed underneath the optical recording medium and is drivable in a radial direction about a rotational axis in a substantially normal direction that is substantially parallel to the optical recording medium focusing direction distancing from or approaching the optical recording medium; in a tracking direction distancing from or approaching the center of the optical recording medium; and in a plurality of normal directions substantially perpendicular to the radial direction of the optical recording medium.

An incident angle denotes an angle between an optical axis and an imaginary axis passing through a center of the objective lens from the light source. The controller radially drives to tilt or rotate the actuator in the radial direction to substantially eliminate the changes of the incident angle generated by movement of the objective lens, thereby reducing aberrations.

The controller seeks to obtain a degree of rotations in the radial direction of the actuator to reduce the aberrations.

The optical pick-up device according to an exemplary embodiment of the present invention further includes a collimating lens to concentrate the light and convert it into parallel light.

The NA of the objective lens is interchangeable with various optical recording media of different specifications.

Other objects, advantages, and salient features of the invention will become apparent from the detailed description, which, taken in conjunction with the annexed drawings, discloses preferred exemplary embodiments of the invention.

### BRIEF DESCRIPTION OF THE DRAWINGS

The above aspects and features of the present invention will be more apparent by describing certain exemplary embodiments of the present invention with reference to the accompanying drawings, in which:

FIG. 1 is a graph illustrating a featured aberration of an objective lens in response to changes of the incident angle;

FIG. 2 is a structural drawing of an optical pick-up device in an infinite optical system according to a first exemplary embodiment of the present invention;

FIG. 3 is a structural drawing of an optical pick-up device in a finite optical system according to a second exemplary embodiment of the present invention;

FIG. 4 is a conceptual drawing illustrating correction of an aberration generated in the optical pick-up device of FIG. 3;

FIG. 5 is a perspective view of an actuator for the optical pick-up device of FIGS. 2 and 3;

FIG. 6 is a graph of a featured aberration in response to the movement of the objective lens when a CD or DVD is reproduced using the optical pick-up device of FIG. 3; and

FIG. 7 is a graph of a featured aberration following adjustment of the objective lens of FIG. 6.

Throughout the drawings, like reference numerals will be understood to refer to like parts, components and structures.

### DETAILED DESCRIPTION OF EXEMPLARY EMBODIMENTS

Certain exemplary embodiments of the present invention are described in greater detail with reference to the accompanying drawings.

The matters defined in the description, such as a detailed construction and elements thereof, are provided to assist in a comprehensive understanding of the present invention. Thus, it is apparent that the present invention may be carried out without those defined matters. Also, well-known functions or constructions are omitted to facilitate providing a clear and concise specification.

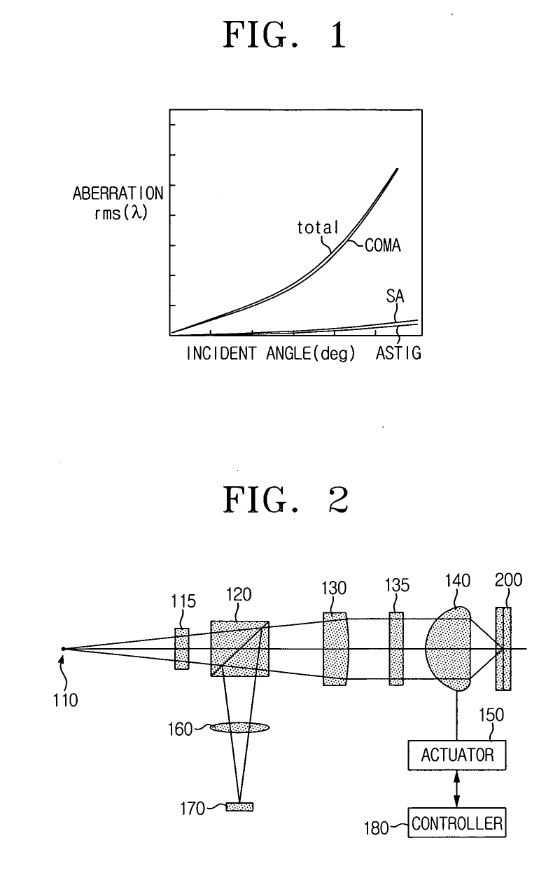

FIG. 2 is a structural drawing of an optical pick-up device in an infinite optical system according to a first exemplary embodiment of the present invention. Referring to FIG. 2, an optical pick-up device according to the first exemplary embodiment of the present invention includes a light source, which is preferably a laser generator 110, a diffracting grating 115, a beam splitter 120, a collimating lens 130, a holographic optical element (HOE) 135, an objective lens (OL) 140, an actuator 150, a YO lens 160, a Photodetector Integrated Circuit (PDIC) 170, and a controller 180.

The light source 110 generates a laser beam of approximately 400 nm to approximately 410 nm used for recording or reproducing information to a BD 200, where the laser beam is polarized.

The diffracting grating 115 splits the laser beam into many beams and concentrates on the BD 200 the additional spots for allowing the OL 140 to accurately chase the tracks on the BD 200.

Referring again to FIG. 2, although the diffracting grating 115 is illustrated, it may not be driven in the driving direction of the actuator 150 such that scope of the present invention is not limited thereto.

The beam splitter 120 uses a polarizing element to reflect the laser beams in response to the polarizing direction, changing the path of the laser beams or passing the laser beams. The beam splitter 120 reflects S-polarized laser beams at approximately a right angle to the PDIC 170 and at the same time is reflected from the BD 200 to pass the P-polarized laser beams. The laser beams having passed the beam splitter 120 are provided to the CL 130.

The CL 130 converges the laser beams from a divergent state to allow the laser beams to advance substantially parallel towards the HOE 135. The CL 130 moves along the light axis to adjust a distance between the CL 130 and the OL 140, such that a focal distance from the laser beams may be changed to form respective focuses on each layer of dual layer.

A dual layer of the BD 200 is shown in FIG. 2, but each layer of the multi-layer may have a plurality of layers formed with focuses.

The HOE 135 is divided therein into an inner hologram part and a quarter wave plate (QWP) such that when a predetermined polarized wave, that is, a P wave, is incident, it is all allowed to pass without any diffraction, and the P wave passes the QWP to be changed to a circularly polarized wave. As a result, the laser beam that is P wave incident from the CL 130 is circularly polarized by the QWP and is provided to the OL 140.

A laser beam reflected from the BD 200 passes the QWP and is again S-polarized, and passes the hologram part to be diffracted in plural light beams. The diffracted lights are incident on the PDIC 170 to conduct focusing and tracking functions.

The HOE 135 may not be used according to characteristics of the optical pick-up device. The HOE 135 is primarily used for 1-beam tracking method, or is used to diffract the lights incident on the OL 140 and to adjust the aberration of the lights converged on the BD 200.

The OL 140 converges the lights to be focused on one of the layers of the BD 200, and the laser beam is reflected from the BD 200.

The optical pick-up device for recording and reproducing for the BD 200, with an object of high density recordation in mind, uses a blue light source of approximately 408 nm and adopts an OL 140 of approximately NA 0.85.

An OL 140 having an NA of approximately 0.65 is employed to record and reproduce a high definition DVD. The high definition DVD is a light disc adopting an OL 140 of high numerical aperture with an object of high density recordation and reproduction of DVDs.

The actuator 150 moves the OL 140 using electromagnetic force and is adapted to be radially tilt-driven. The actuator 150 adjusts movement of the OL 140 so that focused light may be formed on at least one or more of the layers of the BD 200.

Particularly, the actuator 150 moves the position of the OL 140 to reduce the aberrations generated by the combination of the OL 140 and the laser light source of short wavelength. The movement of the OL 140 includes a tilting drive in the radial direction.

Aberration is a kind of error in which light is not completely converged due to technical or structural problems. Although in an ideal optical system, light of any color or coming from any direction is well converged.

The laser beam thus reflected by the BD 200 moves along a light path in the direction opposite from which it was incident, and sequentially passes the OL 140, the HOE 135 and the CL 130. The laser light having passed the OL 140 is S-polarized and reflected by the beam splitter 120 to be converged on the PDIC 170.

The convex or YO lens 160 allows the laser beam reflected from the beam splitter 120 at a right angle to be converged on the PDIC 170. The PDIC 170 converges the laser beams separated in the plurality of spots, and converts an optical signal to an electrical signal.

The controller 180 for a combination of an OL 140 having a high NA and a laser light source of short wavelength seeks a position of the OL 140 that substantially reduces the aberrations generated from the laser beam projected to the BD 200 and controls driving of the actuator 150.

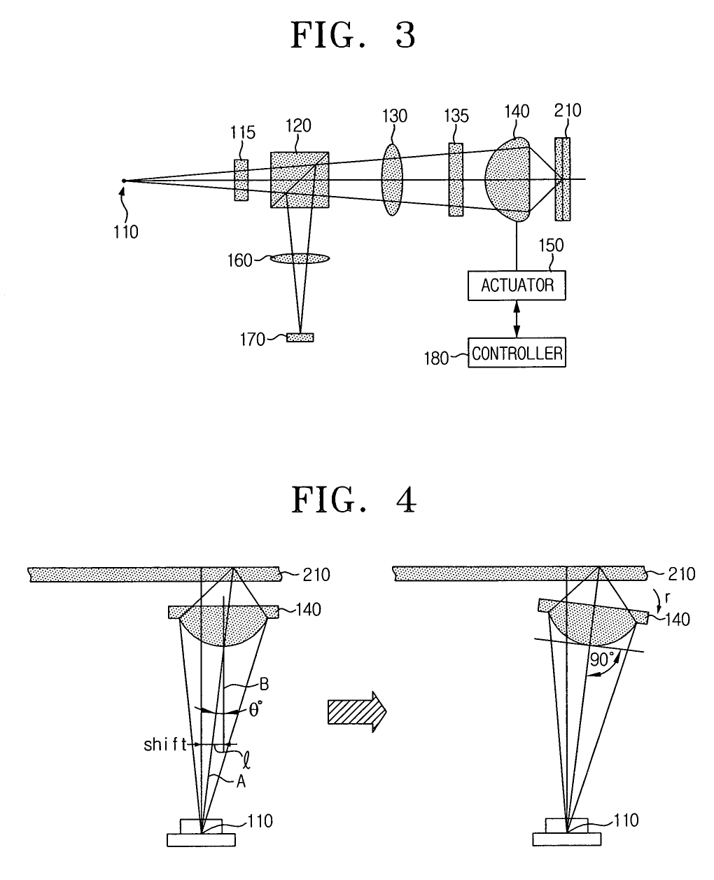

FIG. 3 is a structural drawing of an optical pick-up device in a finite optical system according to a second exemplary embodiment of the present invention. FIG. 4 is a conceptual drawing illustrating correction of an aberration generated in the optical pick-up device of FIG. 3.

An explanation of the optical elements illustrated in FIG. 3, each having the same reference numerals as those of FIG. 2, is omitted because the optical elements of FIG. 3 have substantially the same structure and optical characteristics as those of FIG. 2. However, a thickness of a disc 210 illustrated in FIG. 3 is thicker than that of the BD 200 of FIG. 2, which is a thicker HD-DVD. In the structure of the infinite optical system illustrated in FIG. 2, the position of the CL 130 may be moved to change into the structure of a finite optical system.

The thickness of BD 200 is approximately 0.1 mm, the thickness of the HD-DVD 210 is approximately 0.6 mm, and the thickness of a CD is 1.2 mm such that when using one lens to interchange various discs, it is indispensable to construct an infinite optical system by moving the position of the CL 130.

When changing to an infinite optical system by moving the position of the CL 130, the spherical aberration may be greatly corrected, but because the CL 130 is moved by the thickness difference of discs, an optical aberration is greatly generated in response to the movement thereof. As a result, the aberration may be substantially reduced by tilt-driving in a radial direction of the actuator 150. Furthermore, the NA of the OL 140 may vary for interchangeability with various kinds of other discs of different specifications.

Referring to FIG. 3, which shows the finite optical system in which a moved state of the CL 130 on an optical axis is illustrated for interchangeability with other discs of various specifications, the light that passes the beam splitter 120 is transmitted to the OL 140 in a divergent state.

Although FIG. 3 illustrates transforming the optical pick-up device to a finite optical system by moving the position of the CL 130, exemplary embodiments of the present invention may be applied to a finite optical system where the CL 130 is not so equipped.

The OL 140 receives the laser beam in a divergent state and concentrates the laser beam to allow forming a focus on one of the layers of the BD 200. When an optical disc 210, such as a DVD or CD is reproduced, the OL 140 is moved in various directions to form a focus on a layer of the laser disc.

As illustrated before correction in FIG. 4, the optical disc 210, such as a DVD or CD, is reproduced using the optical pick-up device having a finite optical system, an incident angle of a laser beam emitted from the light source 110 is changed by an angle θ when the OL 140 is moved a distance “l”.

The “incident angle” herein mentioned is an angle formed between a light axis (A) and an imaginary axis (B) that passes through a center of the OL 140 from the light source 110 before the OL 140 is moved the distance “l”.

Although further explanation will be given in the following paragraphs, the actuator 150 may be radially tilt-driven and may correct tilt-driving via radial movement of the aberration generated by the changes of incident angle as much as “r”. The incident angle is changed by the laser beam via radial movement of the actuator 150 as much as “r” may be eliminated.

Correction is illustrated in FIG. 4, in which the OL 140 is vertically moved on a light axis to reduce the aberration following the correction using the radial tilt-driving of the tilt-drivable actuator 150.

The controller 180 calculates a correction value that reduces the aberration generated by the movement of the OL 140 to control the radial tilt-driving of the actuator 150. The amount of movement by the OL 140 in response to the movement of the actuator 150 via the current and voltage values inputted to the actuator 150 may be given, and once the amount of the movement of the OL 140 is known, an incident angle changed by the laser beam may be also known to thereby enable calculation of the correction value for correcting the aberration.

Consequently, the controller 180 may control the radial tilt-driving of the actuator 150 in response to the calculated correction value.

Furthermore, in addition to the method of knowing the amount of movement of the OL 140 in response to the movement of the actuator 150 via the current and voltage values inputted to the actuator 150, there may be another method of knowing an amount of movement of the OL 140 by mounting an optical detection element (not shown) on the actuator 150. The detection element thus explained may be an optical sensor for detecting the position of the OL 140.

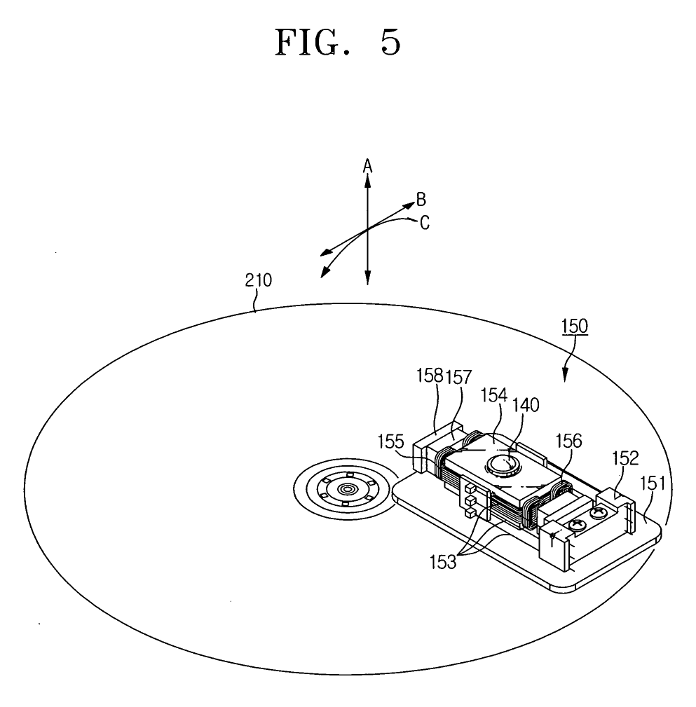

FIG. 5 is a perspective view illustrating an actuator for the optical pick-up device of FIGS. 2 and 3.

Now, referring to FIG. 5, the actuator 150 includes a holder 152 disposed underneath the optical disc 210 and fixed to a base 151. A blade 154 equipped with the OL 140 is flexibly supported on the holder 152 by a plurality of wire suspensions 153 coupled to the holder 152. A focusing coil 155 is disposed at the blade 154 for driving the OL 140 in the focusing direction (A) and tracking direction (B). A magnet 157 generates a magnetic field that interacts with the current respectively flowing in a tracking coil 156. The focusing coil 155, tracking coil 156, and yoke 158 support the magnet 157.

The OL 140 may be moved in the focusing and tracking directions (A and B) via the electromagnetic force generated by the magnet 157, focusing coil 155 and tracking coil 156.

When the current flows in the focusing coil 155, the blade 154 is moved in the focusing direction (A), that is, in a direction distancing from or approaching the optical disc 210, by the current flowing along the focusing coil 155 and the electromagnetic force generated by the interaction of the magnetic field of the magnet 157. As a result, the optical spots of the laser beam irradiated from the OL 140 are focused on the signal track of the optical disc 210 at a predetermined size.

Furthermore, when the current flows in the tracking coil 156, the blade 154 is moved in the tracking direction (B), that is, in a direction distancing from or approaching the center of the optical disc 210 by the current flowing in the tracking coil 156 and the electromagnetic force generated by the interaction of the magnetic field of the magnet 157, such that the optical spots are not deviated from the signal track on the optical disc 216 to facilitate following the signal track.

Tilt-driving in the radial direction (C, FIG. 5) is also possible by supplying a predetermined amount of current.

When the OL 140 is moved by the principle thus described, coma aberration is important to the movement of the tracking direction (B). When the current flowing in the tracking coil 156 and the voltage value at the same position are known, a degree of the movement in the tracking direction (B) of the OL 140 is known, and the incident angle that has changed is also known. Therefore, an effect of correcting aberrations, such as coma aberration, may be obtained by using the tilt-driving in the radial direction (C) of the actuator 150 in response to the changed incident angle.

Furthermore, when a method of automatically generating an inclination of the OL 140 is applied when the asymmetrical structure of the actuator 150 is utilized for movement in the radial direction, there is no need of knowing the current flowing in the tracking coil 156 and the voltage value at the same position. The inclination may be automatically generated if the thickness and length of the wire suspension 153 of the actuator 150 are changed according to the vertical and horizontal positions. The asymmetrical structure of the actuator 150 may be utilized to automatically adjust the inclination of the actuator 150.

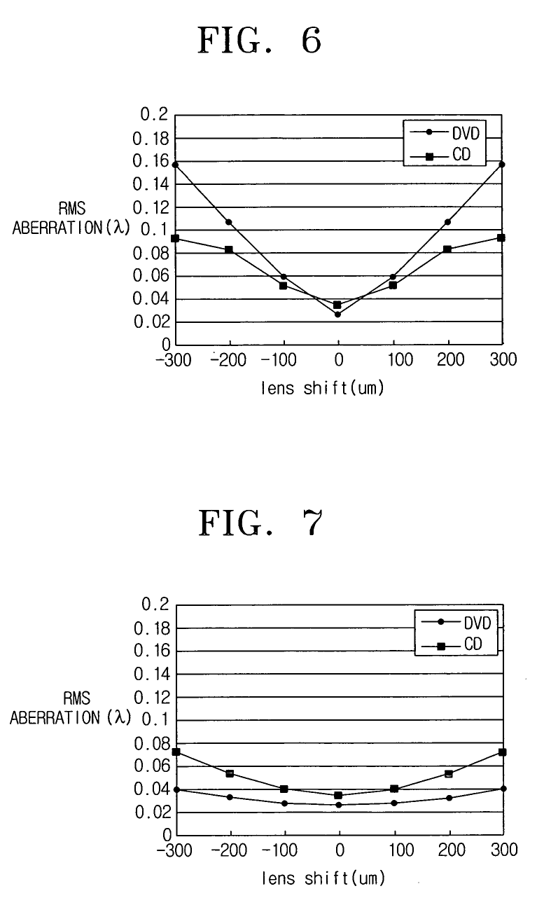

FIG. 6 is a graph illustrating a featured aberration in response to the movement of objective lens when a CD or DVD is reproduced using the optical pick-up device of FIG. 3. FIG. 7 is a graph illustrating a featured aberration following adjustment of the objective lens of FIG. 6.

Referring to FIGS. 1, 6 and 7, a horizontal axis denotes a moved length of the OL 140 and the vertical axis denotes an aberration characteristic relative to the moved length of the OL 140.

Although there is some difference between each graph illustrating the aberration characteristics when reproducing a CD or DVD illustrated in FIG. 6, an abrupt generation of aberration arises relative to the movement of the OL 140.

Meanwhile, when reproducing the CD or DVD illustrated in FIG. 7, although there is some difference in the graph illustrating the reduced aberration characteristic following the actuator 150 being tilt-driven in the radial direction, despite the movement of the OL 140, the aberration has been reduced compared with that of FIG. 6 such that there is almost no occurrence of aberration due to the reduced aberration.

As apparent from the foregoing, the adjustment of the tilt-driving of the actuator 150 in the radial direction may reduce the occurrence of aberrations caused by the movement of the objective lens and use of high NA objective lens.

The foregoing exemplary embodiments and advantages are merely exemplary and are not to be construed as limiting the present invention. The present teaching may be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An optical pick-up device, comprising:
a light source outputting light for recordation and reproduction of information onto and from an optical recording medium;
an objective lens irradiating the light onto the optical recording medium by concentrating the light;
an actuator adjusting movement of the objective lens to focus the light on at least one or more layers of the optical recording medium; and
a controller adapted to move the objective lens to substantially reduce aberrations occurring in the light irradiated onto the optical recording medium by driving the actuator.

2. The device as defined in claim 1, wherein
the controller moves the objective lens in response to a current value or a voltage value inputted into the actuator.

3. The device as defined in claim 1, wherein
the controller moves the objective lens using a light detection element disposed at the actuator.

4. The device as defined in claim 3, wherein
the light detection element is an optical sensor for sensing a position of the objective lens.

5. The device as defined in claim 1, wherein
the controller automatically adjusts an inclination of the actuator using asymmetrical structure of the actuator.

6. The device as defined in claim 1, wherein
the actuator is disposed proximal a surface of the optical recording medium and is movable in three directions.

7. The device as defined in claim 6, wherein
a first direction of movement of the actuator is about a rotational axis substantially parallel to the surface of the optical recording medium.

8. The device as defined in claim 7, wherein
a second direction of movement of the actuator is in a tracking direction toward or away from a center of the surface of the optical recording medium.

9. The device as defined in claim 8, wherein
a third direction of movement of the actuator is substantially perpendicular to the surface of the optical recording medium.

10. The device as defined in claim 1, wherein
an incident angle denotes an angle between an optical axis and an imaginary axis passing through a center of the objective lens from the light source; and
the controller rotates the actuator about a rotational axis to substantially eliminate changes in the incident angle generated by movement of the objective lens, thereby substantially reducing aberrations.

11. The device as defined in claim 9, wherein
the controller rotates the actuator about the rotational axis to substantially reduce aberrations.

12. The device as defined in claim 10, wherein
the controller rotates the actuator about the rotational axis to substantially reduce aberrations.

13. The device as defined in claim 1, wherein
a collimating lens is disposed between the light source and the objective lens to concentrate the light and convert the light into parallel light beams.

14. The device as defined in claim 1, wherein
the numerical aperture (NA) of the objective lens is usable with various optical recording media of different specifications.

15. The device as defined in claim 13, wherein
the collimating lens is movable in a direction substantially parallel to a light axis to adjust a distance between the collimating lens and the objective lens.

16. A method of substantially reducing aberrations associated with an optical pick-up device, comprising the steps of
outputting light from a light source for recording and reproducing information onto and from an optical recording medium;
irradiating the lens onto the optical medium with an objective lens; and
adjusting a position of the objective lens to focus the light on at least one or more layers of the optical recording medium to substantially reduce aberrations.

17. A method of substantially reducing aberrations associated with an optical pick-up device according to claim 16, further comprising
controlling the position of the objective lens with a controller.

18. A method of substantially reducing aberrations associated with an optical pick-up device according to claim 17, further comprising
adjusting the position of the objective lens with the controller in response to a current value or a voltage value input into an actuator to which the objective lens is connected.

19. A method of substantially reducing aberrations associated with an optical pick-up device according to claim 17, further comprising
adjusting the position of the objective lens with the controller in response to a signal received from a light detection element disposed at an actuator to which the objective lens is connected.

20. A method of substantially reducing aberrations associated with an optical pick-up device according to claim 17, further comprising
rotating an actuator to which the objective lens is connected with the controller about a rotational axis substantially parallel to a surface of the optical recording medium.
